(19) United States
(12) Patent Application Publication
(10) Pub. No.: US 2026/0311074 A1
(43) Pub. Date: Oct. 8, 2026

(54) ASSEMBLY LINE VARIANT PATH PLANNING SYSTEM AND METHOD BASED ON GRAPH-BASED DEEP REINFORCEMENT LEARNING

(71) Applicant: GUANGDONG UNIVERSITY OF TECHNOLOGY, Guangzhou (CN)

(72) Inventors: Jiewu LENG, Guangzhou (CN); Qianwei ZHANG, Guangzhou (CN); Tengliang ZHU, Guangzhou (CN); Lianhong ZHOU, Guangzhou (CN); Jiahe LI, Guangzhou (CN); Kailin XU, Guangzhou (CN); Qiang LIU, Guangzhou (CN)

(73) Assignee: GUANGDONG UNIVERSITY OF TECHNOLOGY, Guangzhou (CN)

(21) Appl. No.: 19/460,051

(22) Filed: Jan. 26, 2026

(30) Foreign Application Priority Data
Jul. 21, 2025 (CN) 202511004286.5

(51) Int. Cl. G06Q 10/047; G06F 3/042; G06N 3/092

(52) U.S. Cl. CPC G06Q 10/047; G06F 3/042; G06N 3/092

(57) ABSTRACT

An assembly line variant path planning system based on graph-based deep reinforcement learning includes an input layer, a knowledge and mechanism layer, a core processing module, an output layer, and an application and feedback layer. An assembly line variant process is modelled as a graph structure and a reward function that precisely matches a change propagation preference objective is designed. By using the input change propagation preference mathematical model as a training basis, a neural network model constructed based on graph-based deep reinforcement learning is repeatedly trained until a model output result is stabilized and converged, thereby intelligently identifying an optimal preliminary variant path. A key dimensional linkage skeleton for subsequent instantiated reconstruction is provided by this optimal path, ultimately enabling rapid virtual-physical mapping modeling of the entire assembly process and significantly reducing time for physical assembly line reverse modeling.

### CROSS-REFERENCE TO RELATED APPLICATIONS

This application claims priority to Chinese Patent Application No. 202511004286.5 with a filing date of Jul. 21, 2025. The content of the aforementioned application, including any intervening amendments thereto, is incorporated herein by reference.

### TECHNICAL FIELD

The present disclosure belongs to the field of modern assembly line transformation, and in particular, relates to an assembly line variant path planning system and method based on graph-based deep reinforcement learning.

### BACKGROUND

Under increasingly complex and rapidly changing manufacturing requirements, a modern assembly line is required to possess high flexibility and adaptability to cope with product variants, process adjustments, and fluctuations in market demand. However, it is difficult for an existing assembly line to effectively handle complex environmental information that is high-dimensional and subject to constraints. A traditional meta-heuristic algorithm or experience-based method has significant deficiencies in information processing capability and decision-making efficiency when faced with massive component network structure relationships, equipment states, process parameters, and a plurality of constraint conditions within an assembly line. Therefore, it is difficult to perform efficient optimization searching in complex high-dimensional space. Moreover, the traditional meta-heuristic algorithm or experience-based method is prone to being trapped in local optima, making it difficult to obtain a global optimal solution. In addition, an existing assembly line planning method often relies on intuitive experience of a designer or a fixed optimization strategy. In complex solution space, a local optimal solution is easily obtained through convergence, and a truly global optimal or a superior assembly line variant path cannot be identified, thereby limiting further improvement in assembly line performance.

It cannot be ignored that an existing assembly line transformation method faces a "cold-start" problem under a condition of limited data, resulting in poor model adaptability. Due to inadequate training data, a purely data-driven planning model is severely degraded in performance when historical data is insufficient or when confronted with a new assembly line variant task, and has difficulty in quickly adapting to new environments and working conditions, leading to an unreliable planning result.

Therefore, there is a particularly urgent need for a system capable of constructing a high-precision, and highly-adaptable assembly line variant path planning system, thereby significantly enhancing efficiency and quality of assembly line variant planning.

### SUMMARY OF PRESENT INVENTION

To resolve the aforementioned technical problems in an existing assembly line variant path planning method, including handling high-dimensional complex information, avoiding local optimization, coping with "cold-start" scenarios under limited data, and achieving hybrid data-knowledge-driven planning, the present disclosure provides an assembly line variant path planning system and method based on graph-based deep reinforcement learning.

The technical solutions of the present disclosure are as follows:

An assembly line variant path planning system based on graph-based deep reinforcement learning includes:

an input layer, configured to receive initial information of a to-be-planned assembly line variant requirement as a data source;

a knowledge and mechanism layer, configured to provide a constraint condition;

a core processing module, configured to: exchange data with the input layer and convert the initial information into a graph structure, and perform graph-based deep reinforcement learning using a graph neural network and a reinforcement learning strategy to construct a neural network model; set a reward function matching a change propagation preference objective; and by using the reward function of the change propagation preference objective as a training basis and according to the constraint condition, train the neural network model to obtain an optimal variant path; and

an output layer, configured to: exchange data with the core processing module and output the optimal variant path.

The knowledge and mechanism layer includes a domain experience database and a mechanism model database; and

the domain experience database and the mechanism model database are each configured to exchange data with the core processing module to provide the constraint condition.

The core processing module includes:

a graph-based modeling unit, configured to: exchange data with the input layer and convert the initial information into the graph structure;

a graph-based deep reinforcement learning unit, configured to: exchange data with the graph-based modeling unit, perform, based on the graph structure, graph-based deep reinforcement learning using the graph neural network and the reinforcement learning strategy, and obtain deep-learned graph information data; and

a reward function and optimization objective evaluation unit, configured to: exchange data with the graph-based deep reinforcement learning unit, calculate, based on the deep-learned graph information data and a change propagation preference mathematical model, a reward to obtain a final reward result, and obtain the optimal variant path based on the final reward result, where

the reward function and optimization objective evaluation unit is configured to exchange data with the output layer, to output the optimal variant path.

The core processing module further includes a knowledge fusion unit, where

the knowledge fusion unit is configured to exchange data with the reward function and optimization objective evaluation unit, to provide the constraint condition during construction of the change propagation preference mathematical model.

The graph-based modeling unit is configured to convert the initial information into the graph structure, and is specifically configured to:

convert the initial information into text via a graph-text multimodal model;

perform a cross-multiplication between visual_embedding and text_embedding in the graph-text multimodal model to obtain a to-be-used matrix of [N, N], where N is a natural number;

sequentially multiply values on a diagonal of the to-be-used matrix to obtain paired feature inner products;

compare the paired feature inner products and select a maximum value as a selection item;

obtain an image architecture via an image editor, add positional information to the image architecture, and unfold a feature map into a sequence, to obtain a priority of each graph block; and

correlate the obtained selection item with a position of a graph block having a highest priority until the graph structure is obtained.

The assembly line variant path planning system based on graph-based deep reinforcement learning further includes an application and feedback layer, where

the application and feedback layer is configured to: exchange data with the core processing module, collect actual data from an assembly line applying the optimal variant path, and send the actual data to a reward function and optimization objective evaluation unit in the core processing module, to optimize the optimal variant path.

An assembly line variant path planning method includes:

receiving initial information of a to-be-planned assembly line variant requirement as a data source;

converting the initial information into a graph structure, and performing graph-based deep reinforcement learning using a graph neural network and a reinforcement learning strategy to construct a neural network model, so as to obtain deep-learned graph information data;

setting a reward function matching a change propagation preference objective; and by using the reward function of the change propagation preference objective as a training basis and according to the constraint condition, training the neural network model to obtain an optimal variant path; and

collecting actual data from an assembly line applying the optimal variant path; and optimizing the optimal variant path using the actual data.

The present disclosure at least has the following beneficial effects:

The assembly line variant path planning system provided in the present disclosure is capable of processing non-Euclidean spatial data and features a powerful perception capability and intelligent sequential decision-making, to effectively handle a complex change propagation directed graph in an assembly line variant process, thereby overcoming limitations of a traditional algorithms in processing high-dimensional information and avoiding local optimization. In addition, a graph sample modeling approach is established based on a difference between forward and reverse optimization objectives, including indicator prediction and self-organizing pattern improvement, to meet diverse planning needs, and provide a dimensional linkage framework for instantiated reconstruction, ultimately enabling rapid virtual-physical mapping modeling of the entire assembly process and significantly reducing time required for physical assembly line reverse modeling. The present disclosure offers the advantages of high precision and strong adaptability, thereby substantially enhancing efficiency and quality of assembly line variant planning.

### BRIEF DESCRIPTION OF THE DRAWINGS

FIG. 1 is an overall architecture diagram showing a system according to the present disclosure;

FIG. 2 is a detailed architecture diagram showing a graph-based deep reinforcement learning model; and

FIG. 3 is a flow chart showing a method according to the present disclosure.

### DETAILED DESCRIPTION OF THE EMBODIMENTS

This application is further described below with reference to the accompanying drawings.

### Term explanation:

Graph-based deep reinforcement learning: Graph-based deep reinforcement learning is an extended application of deep reinforcement learning on graph-structured data. A graph neural network can be used to process non-Euclidean spatial data, so as to effectively capture complex topological relationships and feature dependencies between graph nodes, achieving excellent performance in fields such as network optimization, recommendation systems, and path planning.

Knowledge/mechanism model fusion: Knowledge/mechanism model fusion refers to a method of integrating prior knowledge such as domain expert experience, a physical law, a mathematical formula, and an engineering principle or a mechanism-based simulation model with a data-driven machine learning model (for example, a deep learning model). This fusion aims to overcome the "cold-start" problem of a purely data-driven model under a limited data condition, thereby enhancing generalization ability, interpretability, and robustness of the model.

Assembly line variant path planning: Assembly line variant path planning refers to dynamic adjustment and optimization of a structural layout, equipment configuration, process flow, and the like of an assembly line and planning of a series of change steps and paths from a current state to a target state when the assembly line has requirements for product upgrade, process adjustment, capacity expansion, or flexible production in the context of smart manufacturing. An objective of the assembly line variant path planning is to achieve efficient, low-cost, and highly flexible rapid reconfiguration and optimization.

Meta-heuristic algorithm: The meta-heuristic algorithm is an iterative search method for solving a complex optimization problem, to find an approximate optimal solution by simulating natural or physical phenomena, for example a genetic algorithm, particle swarm optimization, and simulated annealing. However, when high-dimensional, multi-constraint, non-linear problems are handled, performance of the meta-heuristic algorithm can be constrained by search space, easily resulting in local optima.

When a current assembly line variant path planning method is applied to a complex manufacturing scenario, a traditional meta-heuristic algorithm and an experience-based method are inadequate in comprehensively perceiving and analyzing increasingly high-dimensional and complex information within the assembly lines, for example, equipment interconnections, process flows, product characteristics, and logistical relationships, leading to one-sided planning decisions. In addition, due to an inherent search mechanism, the traditional method is low in computational efficiency and has a tendency to converge to local optima when facing large-scale, non-convex assembly line variant path planning problems, making it difficult to achieve global optimal or sub-optimal variant paths, thereby affecting overall performance of the assembly line. Moreover, an existing data-driven planning model is highly reliant on a great deal of high-quality training data. In an practical application, especially during a new product introduction or a significant line modification, historical data is usually insufficient. This leads to the "cold-start" problem for the models, resulting in poor generalization ability and weak adaptability to an unknown or abnormal operating condition. In addition, an existing method fails to adequately capture the domino effect that a single change may trigger during the assembly line variant process, resulting in chain reactions across different equipment, workstations, and processes. Failure to effectively model and predict this complexity of change propagation leads to planning outcomes that are inconsistent with actual conditions. In addition, an existing planning method is independent of virtual-physical mapping and reverse modeling processes of physical assembly line. This results in a long validation cycle for a planning solution, hinders rapid iterative optimization, and ultimately prolongs time required for line reconfiguration.

The present disclosure provides an assembly line variant path planning method based on graph-based deep reinforcement learning. The core of the method is to construct an intelligent planning model capable of effectively handling complexity of assembly line variants, overcoming the small-data "cold-start" problem, and identifying optimal variant paths. In the present disclosure, the assembly line variant path planning decisions are actually viewed as a complex change propagation directed graph problem, to identify an optimal variant path through intelligent decision-making. In addition, in the method, the assembly line variant process is modelled as a graph structure and a reward function that precisely matches a change propagation preference objective is designed. By using an input change propagation preference mathematical model as a training basis, a neural network model constructed based on graph-based deep reinforcement learning is repeatedly trained until a model output result is stabilized and converged, thereby intelligently identifying an optimal preliminary variant path. A key dimensional linkage skeleton for subsequent instantiated reconstruction is provided by this optimal path, ultimately enabling rapid virtual-physical mapping modeling of the entire assembly process and significantly reducing time for physical assembly line reverse modeling. Concurrently, to resolve the "cold-start" problem of the model with limited data, the knowledge/mechanism model is innovatively integrated with the learning model in the present disclosure, thereby reducing required training data and computational load while enhancing adaptability of the model to different environments and operating conditions.

### Embodiment 1

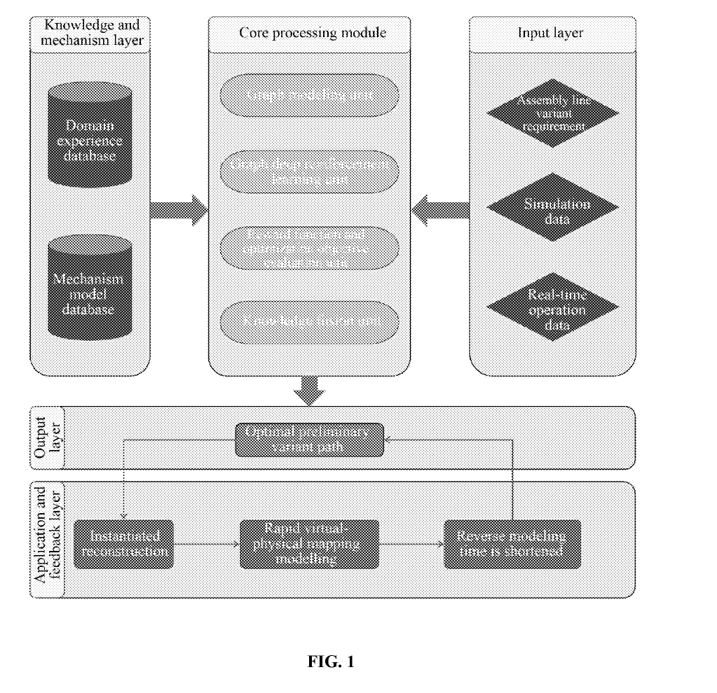

As shown in FIG. 1, an assembly line variant path planning system based on graph-based deep reinforcement learning includes an input layer, a knowledge and mechanism layer, a core processing module, an output layer, and an application and feedback layer.

Specifically, the input layer is responsible for receiving initial information of an assembly line variant requirement as a data source for this embodiment, to integrate simulation data and real-time operation data. A function of the input layer is to provide comprehensive foundational information about a current state of an assembly line and a potential change direction for a subsequent planning process.

Specifically, the knowledge and mechanism layer, as an independent knowledge system, includes a domain experience database and a mechanism model database. A function of the knowledge and mechanism layer is to emphasize importance of prior knowledge and a physical mechanism in the present disclosure, and provide, through interaction with a planning engine, principled guidance and a necessary constraint condition for intelligent decision-making.

Specifically, the core processing module, namely, an intelligent planning and decision-making module, includes a graph-based modeling unit, a graph-based deep reinforcement learning unit, a reward function and optimization objective evaluation unit, and a knowledge fusion unit. A function of the core processing module is mainly to achieve data transformation, strategy learning, result evaluation, and knowledge integration. The graph-based deep reinforcement learning model includes a graph neural network and a reinforcement learning strategy. The reward function and optimization objective evaluation unit is configured to calculate rewards based on a change propagation preference mathematical model. The knowledge fusion unit is configured to embed knowledge into the learning model. The graph-based modeling unit can be configured to convert assembly line information into a graph structure.

Specifically, a function of the output layer is to clearly output an "optimal preliminary variant path", indicating an intelligent decision result obtained after processing by the planning engine. The optimal preliminary variant path is a best variant action sequence generated based on a comprehensive optimization objective, and is directly provided to a downstream application.

Specifically, a downstream application value of a planning result and a potential feedback loop are shown by the application and feedback layer. A function of the application and feedback layer is to promote practical application of planning results in areas including "instantiated reconstruction", "rapid virtual-physical mapping modeling", "shortening physical assembly line reverse modeling time", and the like, reflecting ultimate goals and benefits of the present disclosure and supporting continuous system optimization.

Through the above technical solution, a comprehensive, hybrid data-knowledge-driven digital description of the assembly line variant path planning process is achieved in this embodiment, to construct a high-fidelity intelligent planning system that lays a solid foundation for subsequent detailed algorithm implementation and application. This multi-dimensional, multi-level definition and integration of information facilitates efficient hierarchical and refined management of planning data and models, establishing a solid foundation for building a comprehensive intelligent variant digital twin of the assembly line.

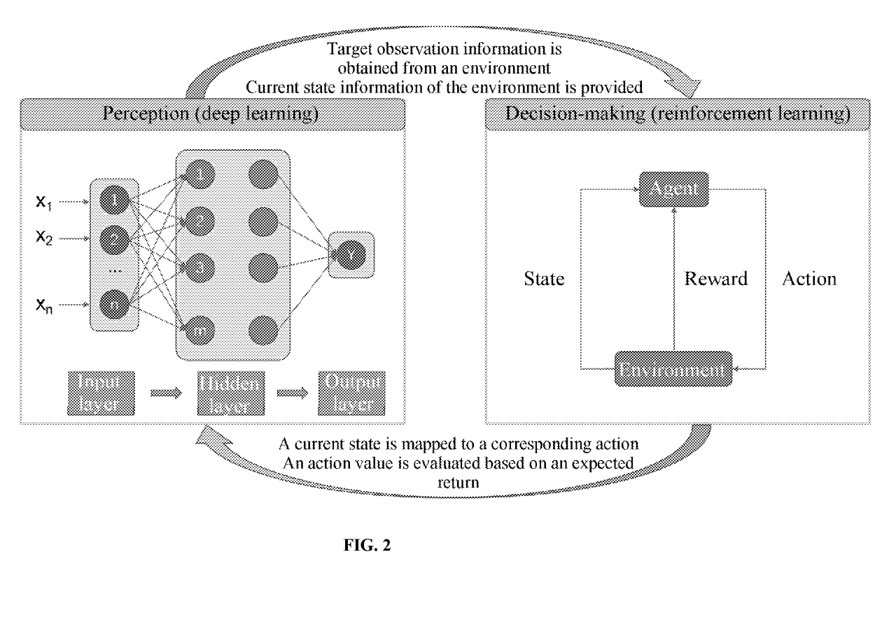

As shown in FIG. 2, the complex decision-making process of assembly line variant path planning is abstracted into a sequential decision-making problem on a change propagation directed graph in this embodiment, and powerful capabilities of graph-based deep reinforcement learning are used for resolving. This process mainly includes construction of the change propagation directed graph, design and optimization of the reward function, and training and convergence of the deep reinforcement learning model.

Specifically, a function of the graph data input module is to transform assembly line variant-related information into the "change propagation directed graph" as model input. Assembly line elements and interrelationships thereof can be dynamically and comprehensively reflected in this graph. Herein, various equipment, product manufacturing features, key workstations, process steps, and other related attributes within the assembly line are defined as graph nodes. An attribute vector of each node can be carried on the node, providing rich input information for the graph neural network. Nodes are connected through directed edges, indicating a change propagation relationship or mutual influences, weights of which are used to quantify intensity or frequency of such influence, for example, logistics intensity or a quantity of matching processing times between equipment and manufacturing features, collectively constructing a topology that is used to capture complex associations and change propagation paths within the assembly line.

Specifically, the graph neural network processing module is used as the core processing unit, and is configured to receive input graph data and effectively process graph-structured data to learn a complex variant strategy. Advanced graph neural network (GNN) architectures including Graph Convolutional Network (GCN), Graph Attention Network (GAT), or GraphSAGE are used by the module as a main body of a strategy network and/or a value network. Through an iterative message-passing mechanism, node features and graph topology information are effectively integrated by GNNs, to extract node embeddings or graph representations rich in semantic meaning, thereby understanding a complex topological structure and an intrinsic relationship within the assembly line variant graph. A GNN network module can be used by the graph neural network processing module.

Specifically, the reinforcement learning decision module is responsible for transforming the features processed by the GNN into executable decisions. The reinforcement learning decision module includes key components of reinforcement learning: Features extracted by the GNN are used by the strategy network, to output a probability distribution over different variant actions, for example, adding equipment, adjusting workstation layout, modifying process parameters under a current assembly line variant state, so as to guide a decision of an agent. A long-term return of a current assembly line variant state or state-action pair is evaluated by the value network. All possible variant actions that the model can execute are defined in action space.

Specifically, a function of a reward calculation and model optimization loop is to provide a critical feedback mechanism, to drive training and optimization of the deep reinforcement learning model. An action executed by a reinforcement learning agent and a new state fed back by the environment are received by using the reward calculation and model optimization loop, and then a reward signal is calculated and generated based on a predefined "change propagation preference mathematical model". The reward function is a core driver for the model to learn the optimal strategy, and is used to precisely match the "change propagation preference objectives" by quantifying multi-objective optimization indicators including variant time, cost, assembly line flexibility, product quality, production efficiency, resource utilization, potential risk mitigation, and the like. After each decision, the reward value is calculated by simulating the environment in real time and is fed back to the agent. Positive rewards encourage beneficial actions, and negative rewards penalize unfavorable ones.

Specifically, the output module is configured to output a final decision result of the trained graph-based deep reinforcement learning model, namely, the "optimal variant strategy" or "optimal variant path sequence", providing precise and efficient decision support for a variant process of the actual assembly line.

Through the above technical solution, the present disclosure successfully transforms the assembly line variant path planning problem accurately into a sequential decision-making process within the graph-based deep reinforcement learning framework. By constructing a detailed change propagation directed graph, designing a reasonable reward function, and training an efficient graph neural network model, an optimal variant path can be intelligently identified in the present disclosure. This overcomes the shortcomings of a traditional method in processing high-dimensional complex information and avoiding local optimization, providing core algorithmic support for the intelligent variant of the assembly line.

### Embodiment 2

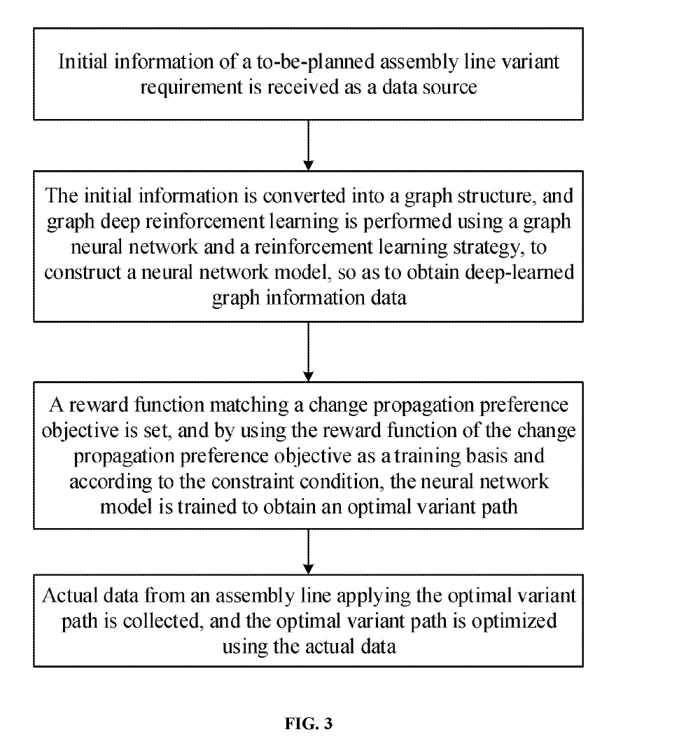

As shown in FIG. 3, an assembly line variant path planning method using the assembly line variant path planning system based on graph-based deep reinforcement learning described in Embodiment 1, includes: receiving initial information of a to-be-planned assembly line variant requirement as a data source; converting the initial information into a graph structure, and performing graph-based deep reinforcement learning using a graph neural network and a reinforcement learning strategy to construct a neural network model, so as to obtain deep-learned graph information data; setting a reward function matching a change propagation preference objective; by using the reward function of the change propagation preference objective as a training basis and according to the constraint condition, training the neural network model to obtain an optimal variant path; and collecting actual data from an assembly line applying the optimal variant path; and optimizing the optimal variant path using the actual data.

The present disclosure further provides an embodiment.

An electronic apparatus includes: a storage medium and a processing unit. The storage medium is configured to store a computer program. The processing unit is configured to perform data exchange with the storage medium. When performing urban local-scale carbon emission calculation and carbon neutrality prediction, the processing unit executes the computer program to carry out the steps of the assembly line variant path planning method as described in Embodiment 2.

A computer-readable storage medium is provided. The computer-readable storage medium stores a computer program. When the computer program is run, the steps of the assembly line variant path planning method as described in Embodiment 2 are performed.

In the present disclosure, the computer-readable storage medium may be any tangible medium that includes or stores a program, and the program may be used by or in combination with an instruction execution system, apparatus, or device. In the present disclosure, the computer readable signal medium may include a data signal propagated in a baseband or as a part of a carrier, and computer-readable program code is carried therein. The propagated data signal may be in various forms, including but not limited to an electromagnetic signal, an optical signal, or any suitable combination thereof. The computer-readable signal medium may alternatively be any computer-readable medium except the computer-readable storage medium. The computer-readable medium may send, propagate or transmit a program used by or used in combination with an instruction execution system, apparatus or device. The program code contained on the computer-readable medium may be transmitted using any suitable medium, including but not limited to: wireless, wire, optical fiber, RF, or any suitable combination thereof.

The above disclosure is only the specific examples of the present disclosure, but the present disclosure is not limited thereto, and all variations conceivable to those skilled in the art should fall within the protection scope of the present disclosure. The serial number of the present disclosure is for a descriptive purpose only and does not indicate the superiority or inferiority of an implementation scenario.

What is claimed is:

1. An assembly line variant path planning system based on graph-based deep reinforcement learning, comprising:
an input layer, configured to receive initial information of a to-be-planned assembly line variant requirement as a data source;
a knowledge and mechanism layer, configured to provide a constraint condition;
a core processing module, configured to: exchange data with the input layer, convert the initial information into a graph structure, and perform graph-based deep reinforcement learning using a graph neural network and a reinforcement learning strategy to construct a neural network model; set a reward function matching a change propagation preference objective; and by using the reward function of the change propagation preference objective as a training basis and according to the constraint condition, train the neural network model to obtain an optimal variant path; and
an output layer, configured to: exchange data with the core processing module and output the optimal variant path.

2. The assembly line variant path planning system according to claim 1, wherein
the knowledge and mechanism layer comprises a domain experience database and a mechanism model database; and
the domain experience database and the mechanism model database are each configured to exchange data with the core processing module to provide the constraint condition.

3. The assembly line variant path planning system according to claim 1, wherein the core processing module comprises:
a graph-based modeling unit, configured to: exchange data with the input layer and convert the initial information into the graph structure;
a graph-based deep reinforcement learning unit, configured to: exchange data with the graph-based modeling unit, perform, based on the graph structure, graph-based deep reinforcement learning using the graph neural network and the reinforcement learning strategy, and obtain deep-learned graph information data; and
a reward function and optimization objective evaluation unit, configured to: exchange data with the graph-based deep reinforcement learning unit, calculate, based on the deep-learned graph information data and a change propagation preference mathematical model, a reward to obtain a final reward result, and obtain the optimal variant path based on the final reward result, wherein
the reward function and optimization objective evaluation unit is configured to exchange data with the output layer, to output the optimal variant path.

4. The assembly line variant path planning system according to claim 3, wherein the core processing module further comprises a knowledge fusion unit, wherein
the knowledge fusion unit is configured to: exchange data with the reward function and optimization objective evaluation unit and provide the constraint condition during construction of the change propagation preference mathematical model.

5. The assembly line variant path planning system according to claim 3, wherein the graph-based modeling unit is configured to convert the initial information into the graph structure, and is specifically configured to:
convert the initial information into text via a graph-text multimodal model;
perform a cross-multiplication between visual_embedding and text_embedding in the graph-text multimodal model to obtain a to-be-used matrix of [N, N];
sequentially multiply values on a diagonal of the to-be-used matrix to obtain paired feature inner products;
compare the paired feature inner products and select a maximum value as a selection item;
obtain an image architecture via an image editor, add positional information to the image architecture, and unfold a feature map into a sequence, to obtain a priority of each graph block; and
correlate the selection item with a position of a graph block having a highest priority until the graph structure is obtained.

6. The assembly line variant path planning system according to claim 1, further comprising: an application and feedback layer, wherein
the application and feedback layer is configured to: exchange data with the core processing module, collect actual data from an assembly line applying the optimal variant path, and send the actual data to a reward function and optimization objective evaluation unit in the core processing module to optimize the optimal variant path.

7. An assembly line variant path planning method using the assembly line variant path planning system according to claim 1, comprising:
receiving the initial information of the to-be-planned assembly line variant requirement as the data source;
converting the initial information into the graph structure, and performing graph-based deep reinforcement learning using the graph neural network and the reinforcement learning strategy to construct the neural network model, so as to obtain the deep-learned graph information data;
setting the reward function matching the change propagation preference objective; and by using the reward function of the change propagation preference objective as the training basis and according to the constraint condition, training the neural network model to obtain the optimal variant path; and
collecting actual data from the assembly line applying the optimal variant path; and optimizing the optimal variant path using the actual data.
